(19) United States
(12) Patent Application Publication
(10) Pub. No.: US 2025/0146585 A1
(43) Pub. Date: May 8, 2025

(54) Systems and Methods for Check Valves with Through-Flow, Grooved Poppets

(71) Applicants: Jesse O. Arias, Grayslake, IL (US); Kevin A. Brown, St. Charles, IL (US)

(72) Inventors: Jesse O. Arias, Grayslake, IL (US); Kevin A. Brown, St. Charles, IL (US)

(73) Assignee: Prince Industries, LLC, Carol Stream, IL (US)

(21) Appl. No.: 18/939,008

(22) Filed: Nov. 6, 2024

Related U.S. Application Data
(60) Provisional application No. 63/596,464, filed on Nov. 6, 2023.

(51) Int. Cl. F16K 15/02

(52) U.S. Cl. CPC F16K 15/026

(57) ABSTRACT

A check valve having a through-flow grooved poppet is provided in which the poppet includes a plurality of helically-oriented grooves around the exterior surface of the poppet, as well as a set of poppet apertures. When the check valve is displaced from a closed position, fluid flows from a first port to a second port by passing through both the set of poppet apertures and the plurality of helically-oriented groves positioned on the exterior of the poppet. The poppet thus provides multiple flow paths which improves the performance of the check valve by reducing the pressure drop upon activation.

### CROSS-REFERENCE TO RELATED APPLICATIONS

The present application claims the benefit of U.S. Provisional Application No. 63/596,464, filed Nov. 6, 2023, entitled “Systems and Methods For Check Valves With Through-Flow, Grooved Poppets”, which is hereby incorporated by reference in its entirety.

### BACKGROUND OF THE INVENTION

The present invention generally relates to a check valves. More particularly, the present invention relates to a check valves for use in hydraulic or pneumatic operation.

A check valve is a one-way valve that allows fluid to flow though in only one direction. In an exemplary embodiment, when in an open position, the check valve may allow fluid to flow from a first, input port to a second, output port. However, in a closed position, no fluid flow takes place.

Check valves typically require a certain amount of pressure, known as the cracking pressure in order to be displaced from a closed position to an open position. Check valves also may experience a pressure drop upon transitioning from a closed position to an open position.

### BRIEF SUMMARY OF THE INVENTION

One or more embodiment of the present invention provide a check valve having a through-flow grooved poppet. The poppet includes a plurality of helically-oriented grooves around the exterior surface of the poppet and a set of poppet apertures. When the check valve is opened, fluid flows from a first port to a second port by passing through both the set of poppet apertures through the interior of the poppet and through the plurality of helically-oriented groves positioned on the exterior of the poppet. The multiple flow paths improve the performance of the check valve by reducing the pressure drop upon activation.

### BRIEF DESCRIPTION OF THE DRAWINGS

FIG. 1 illustrates an exploded view of a first embodiment of a check valve with a through-flow grooved poppet according to an embodiment of the present invention.

FIG. 2 illustrates an assembled view of the check valve of FIG. 1.

FIG. 3 illustrates an embodiment of the check valve of FIG. 1 installed in a manifold.

FIG. 4 illustrates the check valve of FIG. 1 in a “closed” or “neutral” position according to an embodiment of the present invention.

FIG. 5 illustrates the check valve of FIG. 1 in an “open” or “flow” position according to an embodiment of the present invention.

FIG. 6 illustrates a poppet having through-flow grooves according to an embodiment of the present invention.

FIG. 7 illustrates a view of the flow of fluid through the through-flow grooves of the poppet of FIG. 6.

FIG. 8 illustrates an embodiment of the structure of a groove on the exterior of the poppet according to a preferred embodiment.

FIG. 9 illustrates a bottom view of the poppet of FIG. 6 looking into the interior of the poppet from the bottom poppet edge.

FIG. 10 illustrates an exploded view of an alternative embodiment of a check valve with a through-flow grooved poppet having a single set of orifices according to an embodiment of the present invention.

FIG. 11 illustrates and embodiment of the check valve of FIG. 10 installed in a manifold.

FIG. 12 illustrates the check valve of FIG. 10 in a “closed” or “neutral” position according to an embodiment of the present invention.

FIG. 13 illustrates the check valve of FIG. 10 in an “open” or “flow” position according to an embodiment of the present invention.

FIG. 14 illustrates the poppet of FIG. 10 including an alternative poppet orifice.

FIG. 15 illustrates an alternative grooved edge feature of the poppet of FIG. 10.

FIG. 16 illustrates an exploded view of an additional alternative embodiment of a check valve according to an embodiment of the present invention.

FIG. 17 illustrates the check valve of FIG. 16 in a “closed” or “neutral” position according to an embodiment of the present invention.

FIG. 18 illustrates the check valve of FIG. 17 in an “open” or “flow” position according to an embodiment of the present invention.

### DETAILED DESCRIPTION OF THE INVENTION

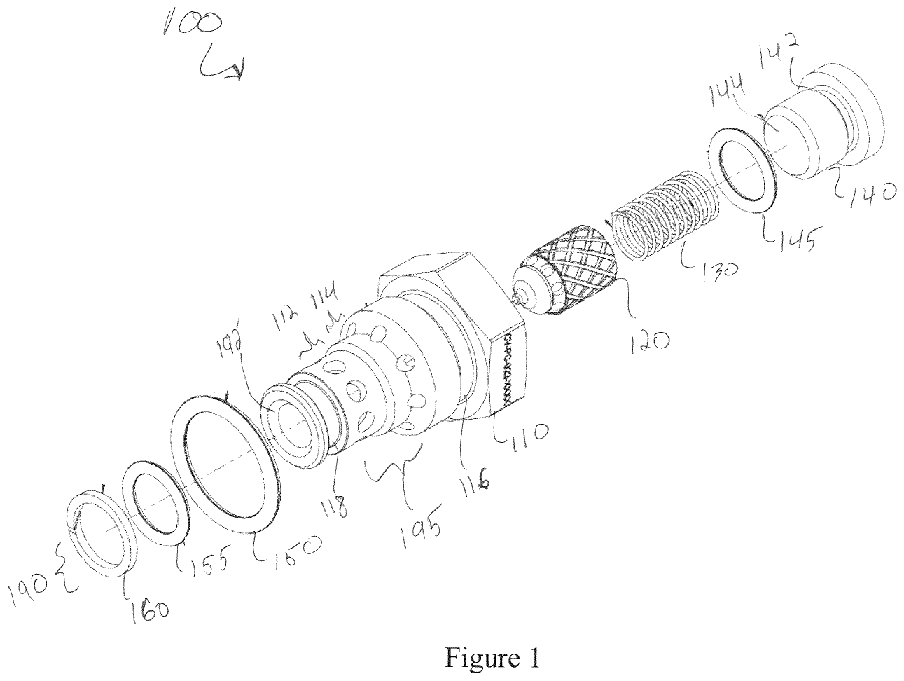

FIG. 1 illustrates an exploded view of a first embodiment of a check valve with a through-flow grooved poppet 100 according to an embodiment of the present invention. The check valve 100 includes a valve body 110, a poppet 120, a poppet spring 130, an end plug 140, a plug seal 145, a manifold seal 150, a first port primary seal 155, and a first port secondary seal 160. The valve body 110 includes a first set of orifices 112 positioned cylindrically around the exterior of the valve body and extending from the interior of the valve body to the exterior of the valve body. The valve body 110 also includes a second set of orifices 114 positioned cylindrically around the exterior of the valve body and extending from the interior of the valve body to the exterior of the valve body. The valve body 110 also includes a manifold seal engagement inset 116 and a first port seal engagement inset 118. The end plug 140 includes a plug seal engagement inset 142 and a poppet spring engagement cylindrical aperture 144.

A first port 190 is formed by fluid passing into a first port inlet 192 of the valve body 110 and into the interior of the valve body 110. A second port 195 is formed by fluid passing from the interior of the valve body 110 to the exterior of the valve body 110 through the first and second set of orifices 112-114.

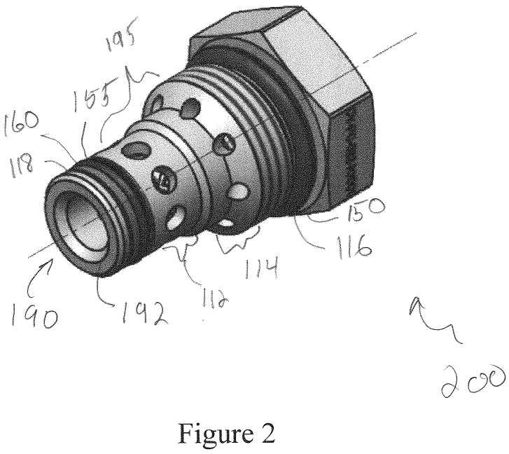

FIG. 2 illustrates an assembled view 200 of the check valve 100 of FIG. 1. As shown in FIG. 2, the first port primary seal 155 and first port secondary seal 160 have been positioned in the first port seal engagement insert 118. Additionally, the manifold seal 150 has been positioned in the manifold seal engagement inset 116. Also, the fluid flow of the first port 190 and second port 195 are shown.

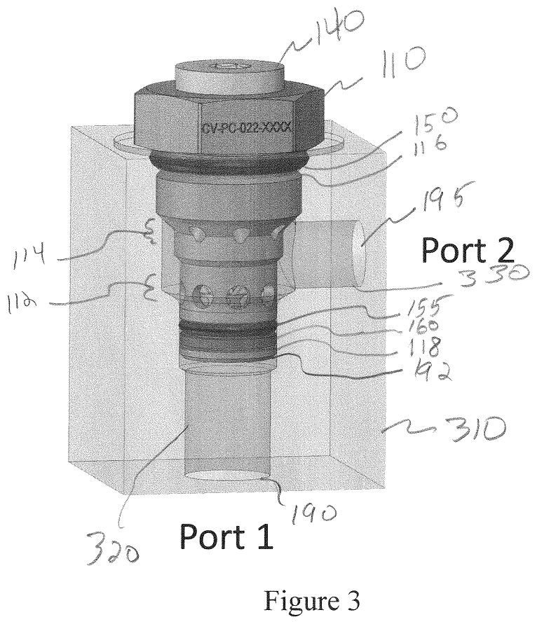

FIG. 3 illustrates an embodiment of the check valve 100 of FIG. 1 installed in a manifold 310. As shown in FIG. 3, the manifold 310 includes a first conduit 320 forming the first port 190, which is an input port, and a second conduit 330 forming the second port 195, which is an output port. As shown in FIG. 3, the first port inlet 192 of the valve body 110 abuts the first conduit 320 of the manifold 310 and allows fluid to pass from the first conduit 320 into the interior of the valve body 110. The first port primary seal 155 and first port secondary seal 160 have been positioned in the first port seal engagement insert 118 and serve to seal the valve body 110 with the manifold 310. Additionally, the manifold seal 150 has been positioned in the manifold seal engagement inset 116 and serves to seal the valve body 110 with the manifold 310. The end plug 140 has also been engaged with the valve body 110. Finally, the first and second set of orifices 112, 114 are shown to be in fluid communication with the second conduit 330 forming the second port 195.

In operation, the check valve 110 operates by allowing flow of fluid from the first port 190 to the second port 195 and preventing (or “checking) flow of fluid from the second port 195 to the first port 190. The check valve 110 may thus provide intermittent, controlled, one-way fluid flow. In one embodiment, check valves may be used to manage fluid flow in hydraulic and/or pneumatic systems, but may be used with other fluids.

FIGS. 1-3 illustrate a cartridge-style check valve developed for use in hydraulic applications. Cartridge check valves are modular components and function together to form a hydraulic system. As shown in FIG. 3, the cartridge check valve screws into a cavity on a hydraulic manifold. The cavity has ports which are separated by seals. The cartridge check valve acts to “check” the fluid by allowing free flow in one direction and preventing flow in the opposite direction.

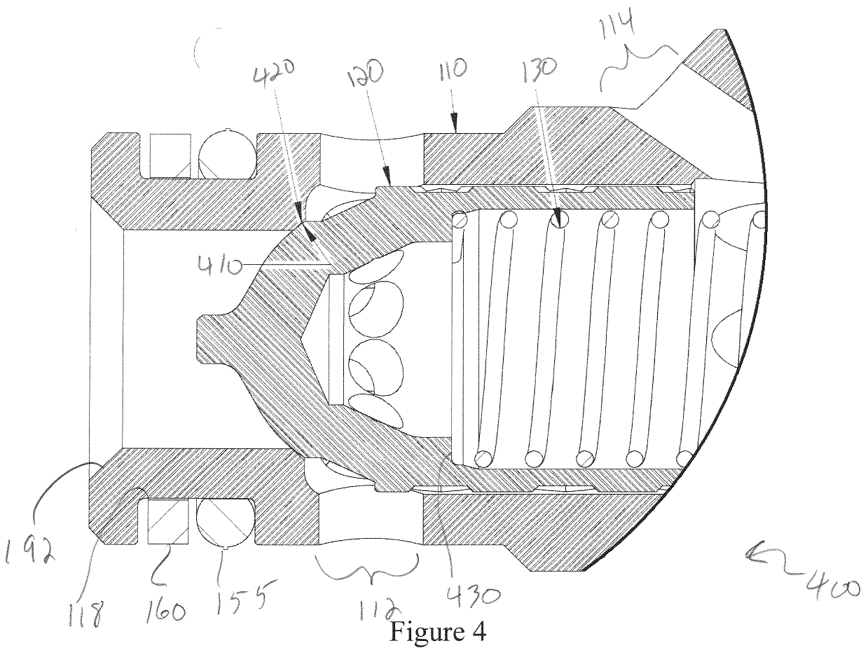

FIG. 4 illustrates the check valve 100 of FIG. 1 in a “closed” or “neutral” position 400 according to an embodiment of the present invention. FIG. 4 shows the valve body 110, poppet 120, poppet spring 130, the first set of orifices 112, the second set of orifices 114, the first port seal engagement insert 118, the first port primary seal 155, the first port secondary seal 160, and the first port inlet 192.

As shown in FIG. 4, a poppet seat 410 of the poppet 120 is in contact with a body seat 420 of the valve body 110. While the poppet seat 410 is in contact with the body seat 420, fluid is prevented from flowing from the first port inlet 192, through the valve body 110 and out of the first and second set of orifices 112-114 that comprise the second port 195.

The poppet seat 410 is maintained in contact with the body seat 420 because one end of the poppet spring 130 engages with the poppet spring engagement ledge 430 of the poppet 120 and the other end of the poppet spring 130 is positioned in the poppet spring engagement cylindrical aperture 144 and engages with the end plug 140. More specifically, when the end plug 140 is engaged with the valve body 110, the poppet spring 130 is compressed between the poppet spring engagement ledge 430 and the end plug 140. The end plug 140 may be engaged with the valve body 110 using frictional engagement or may be screwed into the valve body 110.

The position shown in FIG. 4 may be referred to as the “closed” position because fluid is prevented from flowing from the first port inlet 192, through the valve body 110 and out of the first and second set of orifices 112-114 that comprise the second port 195. Alternatively, the position in FIG. 4 may be referred to as the “neutral” position because it represents the position of the poppet 120 relative to the valve body 110 when no external force is applied, or when insufficient fluid force is applied from said first port 190 to overcome the spring force of the poppet spring 130 and cause the body seat 420 to separate from the poppet seat 410, thus opening the check valve 100.

The seat formed by the contact of the poppet seat 410 with the spring seat 420 seals the check valve 100, and the spring force is related to the valve's pressure setting and may vary. In one embodiment, the seat of the valve is on a diameter, which is called the effective area. As stated another way, the acting or effective area is based on the diameter of the contact surface, but may differ based on factors such as viscosity or flow. Thus, the pressure setting to open the check valve may be calculated as:

$${P}_{setting} = \frac{{F}_{s p r i n g}}{{Area}_{Popp et , effective}} \qquad Equation 1$$

In operation, the check valve 100 operates in one of two operational modes “Flow” and “Checked Flow”. Flow is when fluid passes through the check valve 100 from the first port 190 to the second port 195. Flow occurs when the fluid pressure at the first port 190 is greater than the fluid pressure at the second port 195, and the difference in fluid pressure is greater than the force exerted by the poppet spring 130. Conversely, Checked Flow is when the check valve 100 is in a closed state so that no fluid passes through the check valve 100. Checked Flow may take place when the fluid pressure at the second port 195 is greater than the fluid pressure at the first port 190. Additionally, even if the fluid pressure at the first port 190 is greater than the fluid pressure at the second port 195, if the difference in fluid pressure is less than the force exerted by the poppet spring 130, fluid flow also does not take place.

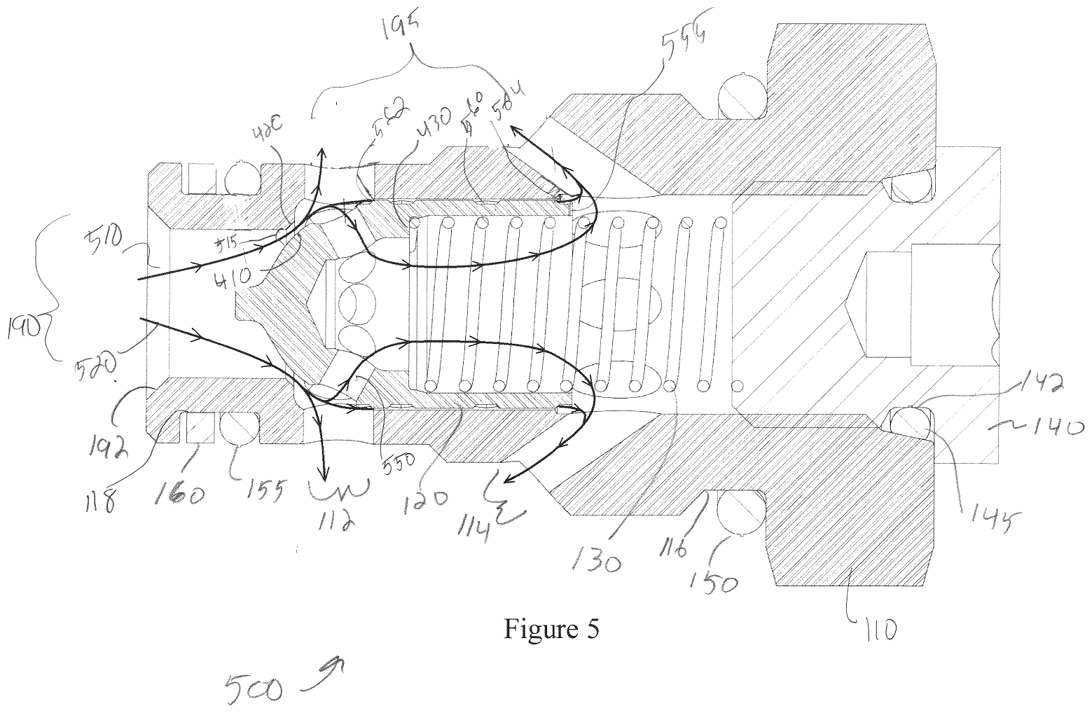

FIG. 5 illustrates the check valve 100 of FIG. 1 in an “open” or “flow” position 500 according to an embodiment of the present invention. FIG. 5 shows the valve body 110, poppet 120, poppet spring 130, the first set of orifices 112, the second set of orifices 114, the first port seal engagement insert 118, the first port primary seal 155, the first port secondary seal 160, and the first port inlet 192. FIG. 5 also shows the manifold seal 150 positioned in the manifold seal engagement inset 116, the end plug 140, and end plug seal 145 positioned in the plug seal engagement insert 142. FIG. 5 additionally shows exemplary flow lines 510, 520, a flow aperture 515, a set of poppet apertures 550, a bottom poppet edge 555, poppet grooves 560, a set of poppet groove inlets 562, and a set of poppet groove outlets 564

As shown in FIG. 5, due to the fluid pressure at the first port 190 being greater than the fluid pressure at the second port 195 and greater than the force exerted by the poppet spring 130, the poppet seat 410 of the poppet 120 is displaced from being in contact with the body seat 420 of the valve body 110. Now that the poppet seat 410 is displaced from contact with the body seat 420, fluid is flowing through a circular or toroidal flow aperture 515 that appears between the poppet seat 410 and the body seat 420.

The flow of fluid from the first port inlet 192 through the valve body 110 is shown by exemplary flow lines 510, 520. The exemplary flow lines 510, 520 are merely examples of fluid flow and do not illustrate all flow of fluid from the first port 190 to the second port 195.

As shown in FIG. 5 and illustrated by the exemplary flow lines 510, 520, fluid may pass from the first port inlet 192 to the second port 195 using any of a variety of paths. First, fluid may pass through the flow aperture 515 and then directly to the first set or orifices 112. This represents a first flow path.

Alternatively, fluid may pass through the flow aperture 515 and then pass through the set of poppet apertures 550 into the interior of the cylindrical poppet 130. As shown in FIG. 5, the bottom poppet edge 555 remains clear of the second set of orifices 114, which allows fluid to pass from the interior of the poppet 130 to the second set of orifices 114. This represents a second flow path.

Additionally, fluid may pass through the flow aperture 515 and then pass through a series of poppet grooves 560 located on the exterior of the poppet 130 and further illustrated below. The poppet grooves 560 include a set of poppet groove inlets 562 located near the first set of orifices 112 that are in fluid communication with a set of poppet groove outlets 564 located near the second set of orifices 114. Fluid may thus pass along the exterior of the poppet 130 in the poppet grooves 560, emerge at the set of poppet groove outlets 564 and then pass out of the second set of orifices 114. This represents a third flow path.

In operation, providing multiple flow paths improves the performance of the check valve 100 by reducing the pressure drop upon activation. When the pressure difference between the two ports exceeds the pressure setting, the poppet 130 moves to the right to open up as shown in FIG. 5. This embodiment offers a parallel flow path. Flow can exit the check valve 110, to the second port 195 through the flow passages of the valve body 110 holes at 112 and 114. The flow through the poppet apertures supplements the primary flow passages at 112. This supplemental flow can improve performance by reducing the pressure needed to pass flow (when compared to the current state of art), and less pressure drop equates to less energy loss for the same flow.

The embodiment of FIG. 5 also includes a compensation design. As noted above, the force to open the valve is the spring force divided by the equivalent area of the poppet seat. When the embodiment of FIG. 5 opens, there is a supplemental area of the poppet exposed to fluid flow. This area is the area between the effective area on the seat and the poppet's outside diameter. This area may also be seen as the exterior surface of the poppet 130 past the poppet seat 410 in the direction of the valve body exit orifices 1112. The pressure gradient caused by flow across this surface causes a lift force. This lift force may also contribute to reduced pressure drop as the poppet 130 becomes more open compared to a valve that has no (or less) flow across the poppet 130.

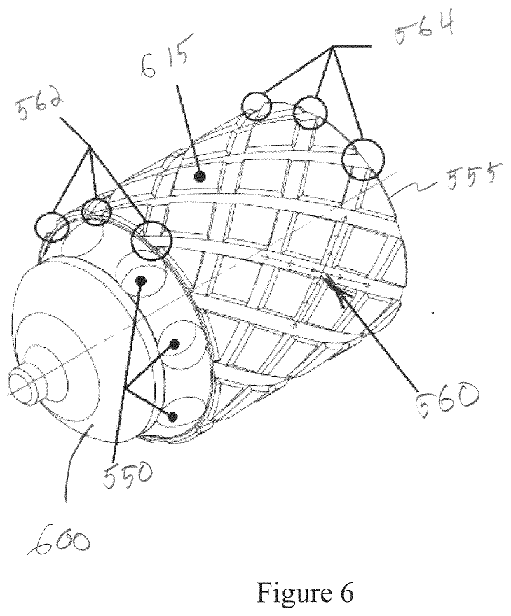

FIG. 6 illustrates a poppet 600 having through-flow grooves 560 according to an embodiment of the present invention. As shown in FIG. 6 and discussed above, the poppet 600 includes a set of poppet apertures 550 that allow fluid to flow into the interior of the cylindrical poppet 600, a set of poppet groove inlets 562 that are connected to a set of poppet groove outlets 564 by the popper grooves. The bottom edge 555 of the poppet is also shown. FIG. 6 also illustrates a raised portion of the poppet exterior wall 615 that is in contact with the interior wall of the valve body 110 when the poppet is installed in the check valve 100.

As shown in FIG. 6, the poppet 600 has helical grooves, with two sets of helical grooves in opposite (crossed) directions. In one embodiment the poppet groove inlets 562 may be known as the groove system entrance apertures and the poppet groove outlets 564 may be known as the groove system exit apertures.

As shown in FIG. 6 grooves are formed in two helical paths initiate at each of the poppet groove inlets 560, one helical path proceeding clockwise around the poppet 600 and the other helical path proceeding counterclockwise around the poppet 600. At several points, groves initiating at a first poppet groove inlet 560 intersect with and are in fluid communication with grooves initiating at a different poppet groove inlet. Additionally, the flow of fluid in the grooves may be in either direction-either toward the bottom poppet edge 555 or away from it.

The size of the poppet grooves 560 may vary. In one embodiment, the poppet apertures 550 are about 1 mm across and 0.3 mm deep. The size of the grooves may be increased or decreased for more or less flow passage. The grooves or “channels” act to distribute flow and pressure around the outside of the poppet 600. Thus, when the poppet 600 is moving to the right (or reciprocating), the paths and pressure distribution of the fluid passing through the grooves acts to center the poppet 600 in the valve body 110 bore. This helps to stabilize the valve, reduce friction and can reduce noise modes.

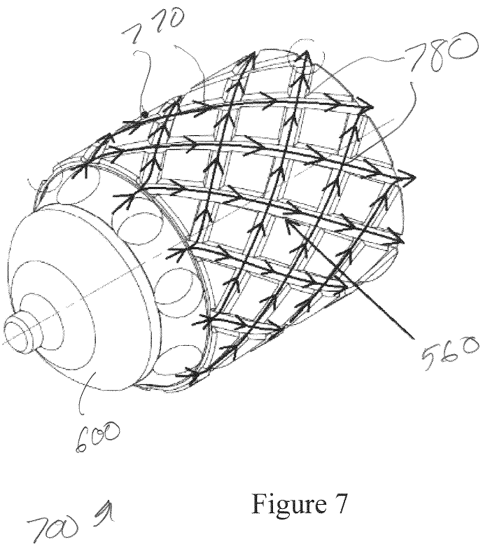

FIG. 7 illustrates a view 700 of the flow of fluid through the through-flow grooves 560 of the poppet 600 of FIG. 6. As shown in FIG. 7, exemplary flow paths 770 may meet at groove intersections 780 and are in fluid communication.

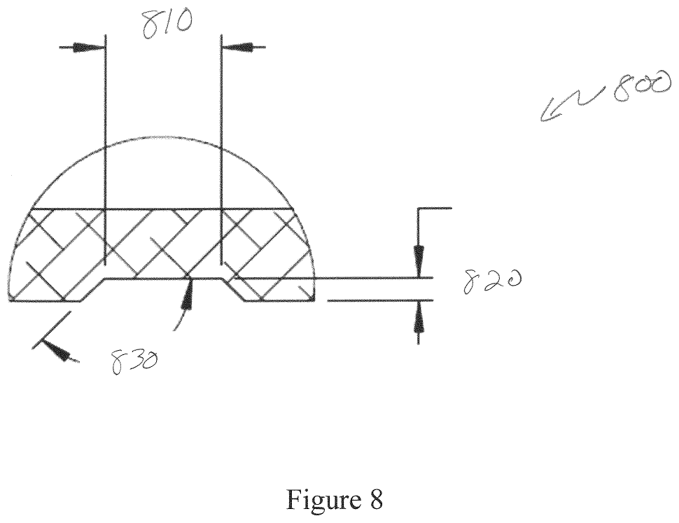

FIG. 8 illustrates an embodiment of the structure of a groove 800 on the exterior of the poppet 600 according to a preferred embodiment. As shown in FIG. 8, the groove 800 includes a groove width 810, a groove height 820, and a grove wall angle 830. In one embodiment, the groove width 810 may be 0.89 inches along the base of the groove, the groove height 820 may be 0.11 inches or 0.24 inches, and the groove wall angle 830 may be 135 degrees. However in other embodiments, the groove width 810 may range between 0.05 to 2.0 inches, the groove height 820 may range between 0.05 and 0.50 inches, and the groove wall angle may range between 90 to 160 degrees.

Additionally, in some embodiments, all grooves on the poppet 600 may include the same dimensions. However, in other embodiments, different grooves on the same poppet 600 may have different dimensions.

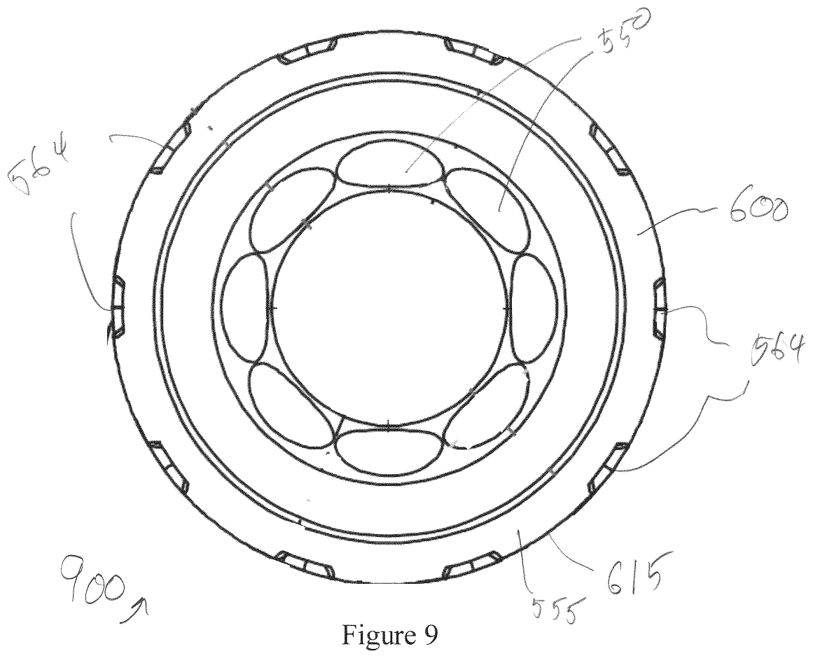

FIG. 9 illustrates a bottom view 900 of the poppet 600 of FIG. 6 looking into the interior of the poppet 600 from the bottom poppet edge 555. Additionally, the end of the poppet 600 opposite the bottom poppet edge 555 may be referred to as the top of the poppet 600. As shown in FIG. 9, the poppet 600 includes 8 poppet apertures 550. However, the number of poppet apertures may range from 4 to 12. Additionally, the poppet 600 includes 10 poppet groove outlets 564 spaced around the circumference of the exterior surface of the poppet. However, the number of poppet groove outlets 564—and/or poppet groves—may range from one to 20. Also shown is the raised portion of the poppet exterior wall 615 that is in contact with the interior wall of the valve body 110 when the poppet is installed in the check valve 100.

We now return to the check valve 100 as shown in the closed position in FIG. 4 to describe the operation of the checked flow. During checked flow, the fluid pressure is higher at the second port 195 than at the first port 190, which causes the poppet seat 410 of the poppet 120 to be pressed against the body seat 420 of the valve body 110. This is similar to the neutral positon, but instead of the poppet seat 410 being held against the body seat 420 by the force of the poppet spring 130 alone, the poppet seat 410 is additionally held against the body seat by the change in fluid pressure between the first port 190 and the second port 195, and this pressure may be much greater than the spring force.

In the checked flow operation, the check valve 100 still maintains its integrity and seal to the rated pressure. The manifold seal 150, first port primary seal 155 and first port secondary seal 160 block the passage of oil (or another internal fluid) to the external environment. Internally to the valve body 110, the poppet seat 410 and the body seat 420 seals the oil (or another fluid) between the poppet 120 and the valve body 110. Sealing the internal oil (or another fluid) is important. Some check valves are used for load holding and leakage may cause the hydraulic actuator connected to the check valve to leak. As such there are several important characteristics including surface finish and contact stress. The surface finish should be adequate to seal the oil, and the contact stress should be below the materials limit. While larger contact areas reduce the stress on the material, surface defects and finishes may lead to leakage. Thus, the contact surfaces of both the poppet seat 410 and the body seat 420 are preferably as smooth or flat as possible and with as few flaws as possible, so that the surfaces of the seats form a strong, continuous contact for the totality of the diameter of where the seats are in contact. There are several geometries to the seat: Angle to angle, Spherical to spherical, and spherical to angle. The embodiment shown in FIG. 4 uses a spherical to angle. This allows the design to have a tangent (theoretical line) contact, and as poppet force increases, the tangent contact deforms to distribute the area. The deformation is mostly elastic, but may also include local plastic deformation. Selection of material has benefits to deformation and/or stress limit. In one embodiment, a “strong” material that elastically deforms with “good” strength has beneficial properties Poppet/Body/Seat design. In one embodiment, a pliable metal such as aluminum may be employed as opposed to the steel-based seats used in the prior art. A more pliable metal may allow the poppet seat 410 and body seat 410 to more easily confirm to each other, even in the presence of microscopic flaws, and may thus provide a stronger seal. The elastic deformability of the seats may be described by using their modulus of elasticity, with steel having a modulus of about 30 MPSI (Mega-pounds-per-square-inch) and aluminum having a modulus of about 10 MPSI, It has been found that the seal between the seats may be improved by having one or both of the seats be composed of a metal having a modulus in the range of 8-20 MPSI, more preferably in the range of 9-12 MPSI, and even more preferably around 10 MPSI. A reduced mass Poppet also reduces impact energy (½ mv\hat{ }2). The current embodiment uses an “aerospace” aluminum poppet and low-alloy steel valve body to leverage these benefits. However, other materials may be employed in other embodiments. In one embodiment, a low mass poppet may be a poppet where the mass of the poppet divided by the mass of a steel sphere of the same diameter as the exterior of the poppet is in the range of 0.15 to 0.28, and more preferably equal to or less than 0.25.

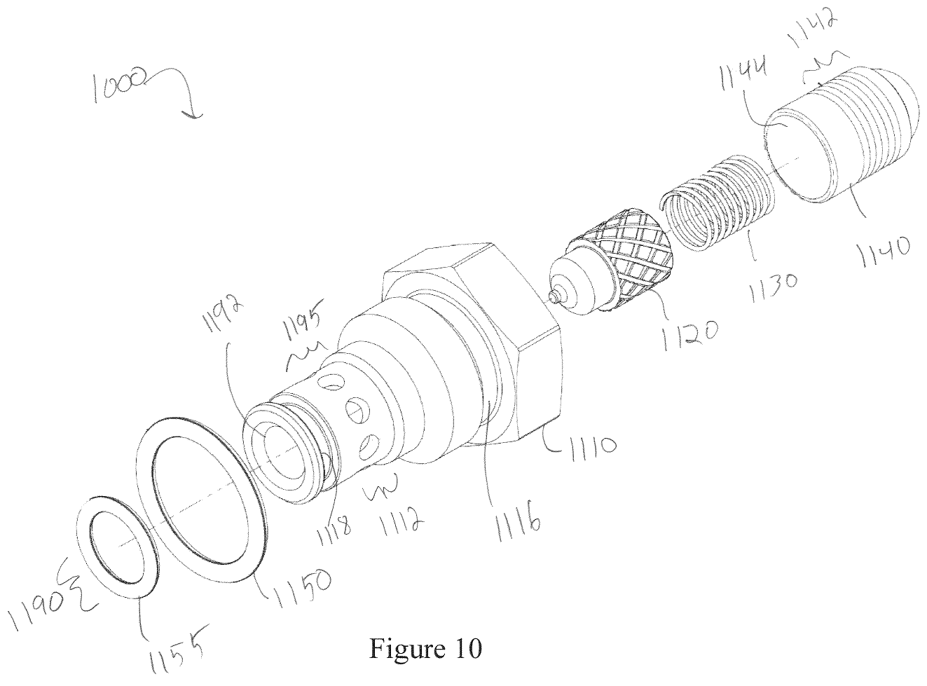

FIG. 10 illustrates an exploded view of an alternative embodiment of a check valve with a through-flow grooved poppet having a single set of orifices 1000 according to an embodiment of the present invention. The check valve 1000 of FIG. 10 includes a valve body 1110, a poppet 1120, a poppet spring 1130, an end plug 1140, a manifold seal 1150, and a first port seal 1155. The valve body 1110 includes a set of valve body exit orifices 1112 positioned cylindrically around the exterior of the valve body and extending from the interior of the valve body to the exterior of the valve body. The valve body 1110 also includes a manifold seal engagement inset 1116 and a first port seal engagement inset 1118. The end plug 1140 includes a threaded plug portion 1142 and a poppet spring engagement cylindrical surface 1144.

A first port 1190 is formed by fluid passing into a first port inlet 1192 of the valve body 1110 and into the interior of the valve body 1110. A second port 195 is formed by fluid passing from the interior of the valve body 1110 to the exterior of the valve body 1110 through the valve body exit orifices 1112.

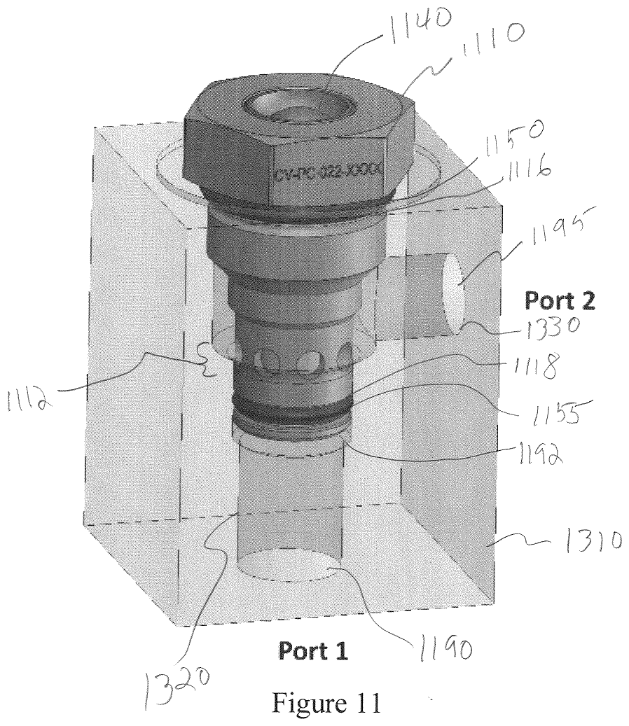

FIG. 11 illustrates and embodiment of the check valve 1100 of FIG. 10 installed in a manifold 1310. As shown in FIG. 11, the manifold 1310 includes a first conduit 1320 forming the first port 1190, which is an input port, and a second conduit 1330 forming the second port 1195, which is an output port. As shown in FIG. 11, the first port inlet 1192 of the valve body 1110 abuts the first conduit 1320 of the manifold 1310 and allows fluid to pass from the first conduit 1320 into the interior of the valve body 1110. The first port seal 1155 has been positioned in the first port seal engagement insert 1118 and serves to seal the valve body 1110 with the manifold 1310. Additionally, the manifold seal 1150 has been positioned in the manifold seal engagement inset 1116 and serves to seal the valve body 1110 with the manifold 1310. The end plug 1140 has also been engaged with the valve body 1110 by threading the threaded plug portion 1142 into a threaded section positioned on the interior surface of the valve body 1110. Finally, the valve body exit orifices 1112 are shown to be in fluid communication with the second conduit 1330 forming the second port 1195.

In operation, the check valve 1110 of FIG. 10 operates similarly to the check valve 100 of FIG. 1 by allowing flow of fluid from the first port 1190 to the second port 1195 and preventing (or “checking) the flow of fluid from the second port 1195 to the first port 1190. However, the check valve 1110 of FIG. 10 includes only a single set of valve body exit orifices 1112 and a different poppet structure.

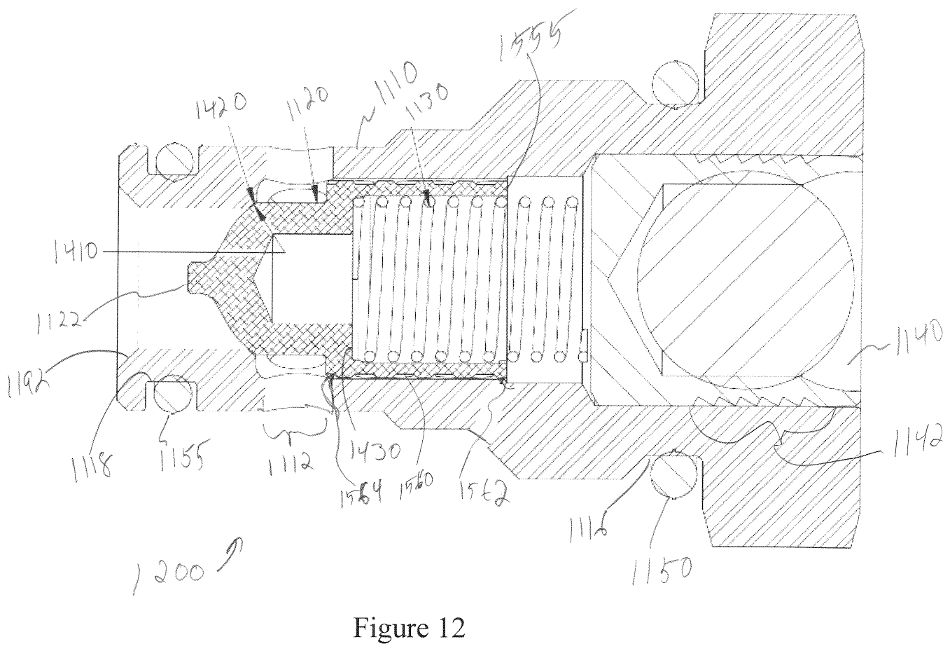

FIG. 12 illustrates the check valve 1000 of FIG. 10 in a “closed” or “neutral” position 1200 according to an embodiment of the present invention. FIG. 12 shows the valve body 1110, poppet 1120, poppet spring 1130, valve body exit orifices 1112, the first port seal engagement insert 1118, the first port seal 1155, the first port inlet 1192, the end plug 1140, the threaded plug portion 1142, the manifold seal 1115, and the manifold seal engagement inset 1116. FIG. 12 also shows a poppet seat 1410, a body seat 1420, and a poppet spring engagement ledge 1430. Also shown in FIG. 12 are a bottom poppet edge 1555, poppet grooves 1560, a set of poppet groove inlets 1562, and a set of poppet groove outlets 1564.

As shown in FIG. 12, the poppet seat 1410 of the poppet 1120 is in contact with the body seat 1420 of the valve body 1110. While the poppet seat 1410 is in contact with the body seat 1420, fluid is prevented from flowing from the first port inlet 1192, through the valve body 1110 and out of the valve exit orifices 1112 that comprise the second port 1195.

Similar to the embodiment of FIG. 1 above, the poppet seat 1410 is maintained in contact with the body seat 1420 because one end of the poppet spring 1130 engages with the poppet spring engagement ledge 1430 of the poppet 1120 and the other end of the poppet spring 130 is positioned on the poppet spring engagement surface 1144 of the end plug 1140. More specifically, when threaded plug portion 1142 of the end plug 1140 is engaged with the threaded portion of the valve body 1110, the poppet spring 1130 is compressed between the poppet spring engagement ledge 1430 and the poppet spring engagement surface 1144 of the end plug 140.

Similar to the embodiment of FIG. 1 above, for the check valve 1000 of FIG. 10, in its neutral position, spring force closes the seat between the poppet seat 1410 and the body seat 1420. The interface or “seat” connection is low leakage and designed for structural need. The valve changes modes of operation from the neutral position to flow position when the pressure at the first port 1190 increases. The “crack” setting is also similar to the embodiment of FIG. 1 above. When the force of the pressure at the first port 1190, acting on the effective area of the poppet 1120 is greater than the spring force of the poppet spring 1130, the poppet 1120 moves to the right and opens. When open, fluid flow begins to pass through the valve body 1110 from the first port 1190 to the second port 1195 through the opening created between the poppet seat 1410 and the body seat 1420.

Additionally. the helical passages or grooves or apertures allow fluid flow to pass between the two sides of the poppet 1120 and the interior walls of the valve body 1110. As shown in FIG. 12, the left side is the closed side of the poppet 1120 with the “nose” or centering feature 1122, and the right side is the open side where the poppet spring 1130 is installed. The left side is the side passing flow across the seat which is the region between the poppet seat 410 and the body seat 420. The right side includes a grooved edge of the poppet 1120 as shown below.

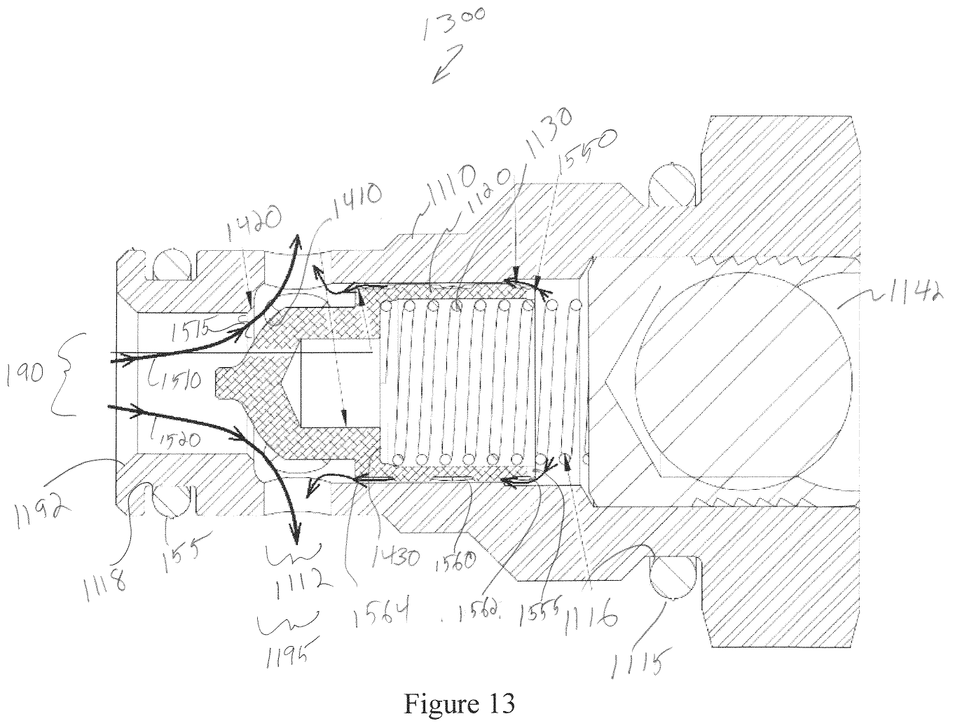

FIG. 13 illustrates the check valve 1000 of FIG. 10 in an “open” or “flow” position 1300 according to an embodiment of the present invention. FIG. 13 shows the valve body 1110, poppet 1120, poppet spring 1130, valve body exit orifices 1112, the first port seal engagement insert 1118, the first port seal 1155, the first port inlet 1192, the end plug 1140, the threaded plug portion 1142, the manifold seal 1115, and the manifold seal engagement inset 1116. FIG. 12 also shows a poppet seat 1410, a body seat 1420, and a poppet spring engagement ledge 1430. Also shown in FIG. 12 are a bottom poppet edge 1555, poppet grooves 1560, a set of poppet groove inlets 1562, and a set of poppet groove outlets 1564.

As shown in FIG. 13, due to the fluid pressure at the first port 1190 being greater than the fluid pressure at the second port 1195 and greater than the force exerted by the poppet spring 1130, the poppet seat 1410 of the poppet 1120 is displaced from being in contact with the body seat 1420 of the valve body 1110. Once that the poppet seat 1410 is displaced from contact with the body seat 1420, fluid begins flowing through a circular or toroidal flow aperture 1515 that appears between the poppet seat 1410 and the body seat 1420.

The flow of fluid from the first port inlet 1192 through the valve body 1110 is shown by exemplary flow lines 1510, 1520. The exemplary flow lines 1510, 1520 are merely examples of fluid flow and do not illustrate all flow of fluid from the first port 1190 to the second port 1195. Back side fluid flow lines 1555 show an example of the flow of fluid from the back side of the poppet 1120 through poppet grooves 1560 and then to the second port 1195

As shown in FIG. 13 and illustrated by the exemplary flow lines 1510, 1520, fluid may pass through the flow aperture 515 and then directly to the valve body exit orifices 1112. This represents a first flow path.

Additionally, as the poppet 1120 is displaced to the right, fluid that occupies the space to the right of the poppet and in the hollow interior of the poppet 1120 when the poppet is in the neutral position may be induced to enter the poppet groove inlets 1562, located near the bottom poppet edge 1555 in the present embodiment. From there, the fluid may flow along the poppet grooves 560 to the poppet groove outlets 564 located near the valve body exit orifices 1112, and then pass through the valve body exit orifices 1112. This represents a second flow path.

In operation, as mentioned above, providing multiple flow paths improves the performance of the check valve 1000 by reducing the pressure drop upon activation. This supplemental flow can improve performance by reducing the pressure needed to pass flow (when compared to the current state of art), and less pressure drop equates to less energy loss for the same flow.

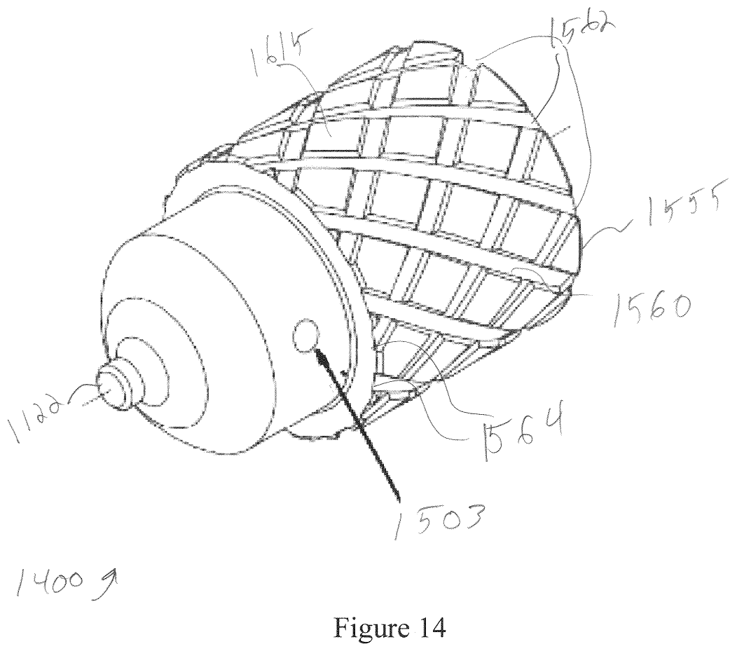

FIG. 14 illustrates the poppet 1120 of FIG. 10 including an alternative poppet orifice 1503. The poppet 1120 is similar to the poppet 120 of FIG. 1, but does not include the poppet apertures 550 on the front of the poppet. As an initial matter is should be noted that any of the poppet embodiments and alternatives herein may be substituted with the various embodiments of the valve bodies. However, because the embodiment of the check valve 1000 of FIG. 10 lacks the second set of orifices 114, flow through and/or around the poppet 1120 may be less than in the embodiment of FIG. 1.

However, as illustrated in FIG. 14, the poppet 1120 may include a poppet orifice 1503. The poppet orifice 1503 may be positioned proximal to the front end of the poppet 1120, such as on a cylindrical wall of the poppet 1120 parallel to the direction of offset when the poppet is displaced, as shown in FIG. 14. The poppet orifice 1503 allows fluid to flow from the interior of the poppet 1120 to the front end of the poppet 1120 when the poppet is displaced to the right in the embodiment of FIG. 13. This represents a third flow path which may increase the performance of the check valve 1000.

The poppet orifice 1503 also connects the “left” and “right” side of the poppet 1120, which may communicate pressure or flow. The communication of pressure avoids a hydraulic locking condition. Additionally, the helical grooves mitigate the potential hydraulic locking condition. In one embodiment, the helical grooves may replace the orifice, but may also be used in conjunction.

In some embodiments, different closing or sealing methods for the check valve may be employed. For example, the end plug 140 shown in the embodiment of FIG. 1 may be frictionally or adhesively engaged with the interior surface of the valve body. Conversely, the end plug 1140 of shown in the embodiment of FIG. 10 may be a threaded or “expanded” type plug. However, either end plug may be used in any embodiment. The end plug in FIG. 1 may be called a Port Plug. Port Plugs are available in various sizes and are occasionally used in the current state of the art. The Plug in FIG. 6 10 may be called an Expander Plug. These plugs come in various sizes. The common use for these plugs is to seal holes in hydraulic manifolds, but they are not employed to seal check valves. Using the Expander plug may eliminate the use of the plug seal 145 o-ring shown in FIG. 1, and a threaded joint. The threaded joint may be replaced by the pressed in joint between the Expander Plug and the valve body.

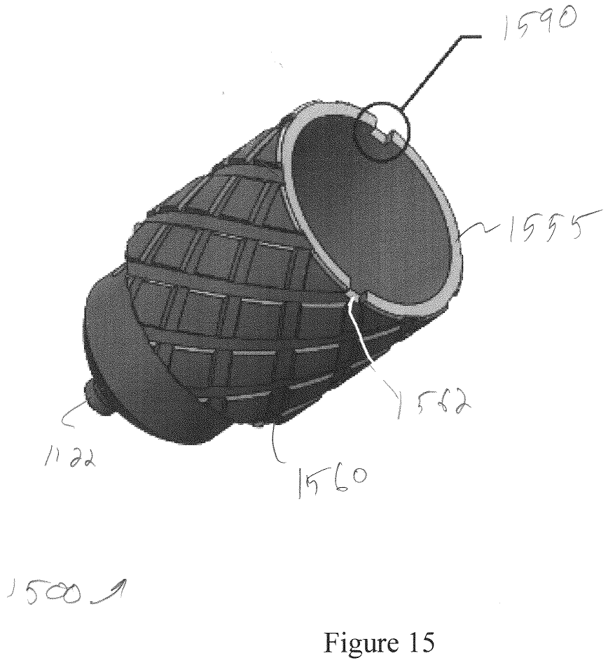

FIG. 15 illustrates an alternative grooved edge 1590 feature of the poppet 1120 of FIG. 10. As shown in FIG. 15, the bottom poppet edge 1555 includes a cut-away portion positioned where the poppet groove inlets 1562 meet the bottom poppet edge 1555. The cut-away portion is shown as a notch that has a displaced top edge toward the front portion of the poppet 1120 and extends the width of the poppet groove inlet 1562. The alternative grooved edge 1590 may lessen resistance to fluid flow, which may thus increase the performance of the check valve 1000. The alternative grooved edge 1590 may be employed with any of the poppet embodiments herein. The grooved edge 1590 may also help mitigate hydraulic locking, especially when the poppet 1120 is fully moved to the right.

With the neutral position and flow positions of the alternative embodiment described, the next mode of operation is “checked” flow. Checked flow occurs when the pressure at the second port 1195 (on the right) is higher than the pressure at the first port 1190 (on the left). In this condition, the difference in pressure, combined with the spring force, causes the valve to close. The poppet 1120 then resumes a similar position as the neutral position. This mode is intended to be exposed to higher pressures. Similar to the first embodiment, check valves may be exposed to high pressures and be used to capably hold hydraulic loads.

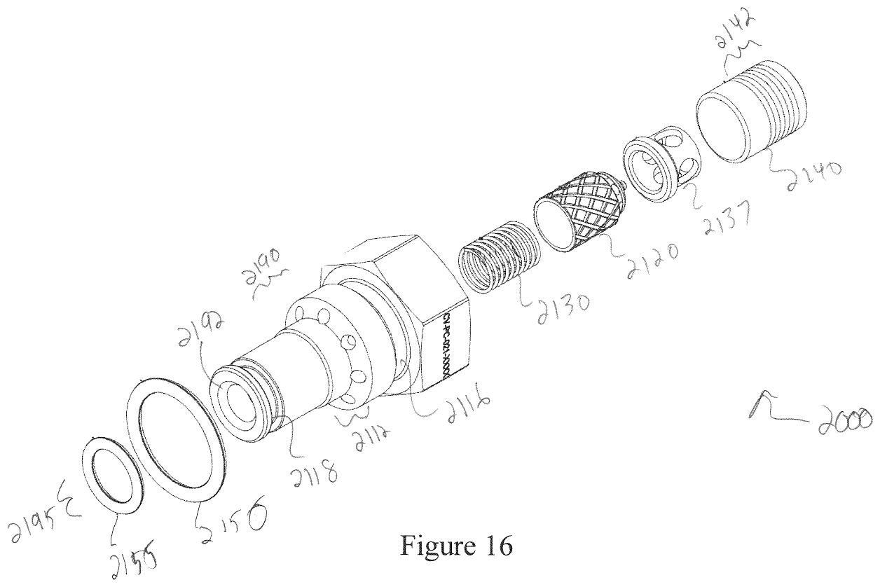

FIG. 16 illustrates an exploded view of an additional alternative embodiment of a check valve 2000 according to an embodiment of the present invention. The check valve 2000 of FIG. 16 includes a valve body 2110, a poppet 2120, a poppet spring 2130, a poppet seating structure 2137, an end plug 2140 including a threaded portion 2142, a manifold seal 2150, and a second port seal 2155. The valve body 2110 includes a set of valve body entrance orifices 2112 positioned cylindrically around the exterior of the valve body and extending from the exterior of the valve body to the interior of the valve body. The valve body 2110 also includes a manifold seal engagement inset 2116 and a second port seal engagement inset 2118, as well as a second port outlet 2192. The end plug 2140 includes a threaded plug portion 2142. A first port 2190 is formed by fluid passing into the valve body entrance orifices 2112. A second port 2195 is formed by fluid passing from the interior of the valve body 2110 out through the second port outlet 2192.

The embodiment of FIG. 16 may be called a reverse flow check valve. In the embodiment of FIG. 16, the poppet 2120 is configured in the opposite direction from the embodiments described above. The reverse flow check valve allows free fluid flow from the first port 2190 to the second port 2195, but checks or stops flow in the opposite direction.

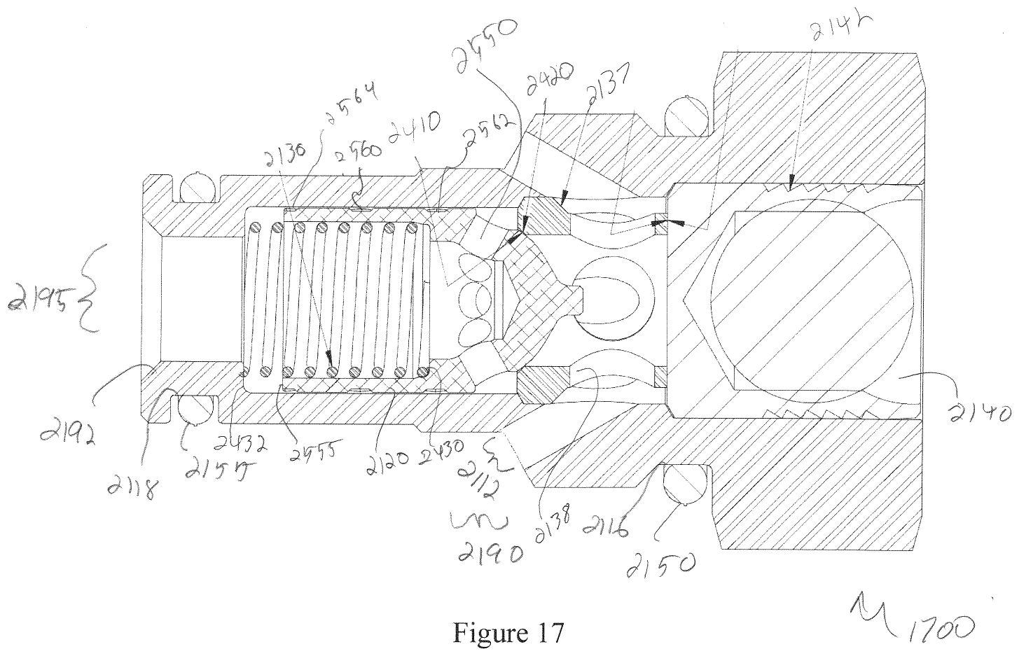

FIG. 17 illustrates the check valve 2000 of FIG. 16 in a “closed” or “neutral” position 1700 according to an embodiment of the present invention. FIG. 17 shows the valve body 2110, poppet 2120 including a set of poppet apertures 2550, poppet spring 2130, poppet seat 2137 including poppet seat apertures 2138, end plug 2140 including the threaded portion 2142, the manifold seal 2150, manifold seal engagement inset 2116, second port seal 2155, second port seal engagement inset 2118, valve body entrance orifices 2112, second port outlet 2192. The first port 2190 and the second port 2195.

Additionally, FIG. 17 also shows that the poppet seating structure 2137 that includes a seating structure seat 2420 that comes into contact with the poppet seat 2410. Also shown is a poppet spring engagement ledge 2430 and a valve body spring engagement ledge 2432. Also shown in FIG. 12 are a bottom poppet edge 2555, poppet grooves 2560, a set of poppet groove inlets 2562, and a set of poppet groove outlets 2564.

As shown in FIG. 17, the poppet seat 2410 of the poppet 2120 is in contact with the seating structure seat 2420 of the poppet seating structure 2137. While the poppet seat 2410 is in contact with the seating structure seat 2420, fluid is prevented from flowing from the first port 2190, through the valve body 2110 and out of the second port outlet 2192 that comprise the second port 2195.

Similar to the embodiment of FIG. 1 above, the poppet seat 2410 is maintained in contact with the seating structure seat 2420 because one end of the poppet spring 2130 engages with the poppet spring engagement ledge 2430 of the poppet 2120 and the other end of the poppet spring 230 engages with the valve body spring engagement ledge 2432. More specifically, when threaded plug portion 2142 of the end plug 2140 is engaged with the threaded portion of the valve body 2110, the poppet spring 2130 is compressed between the poppet spring engagement ledge 2430 and the valve body spring engagement ledge 2432.

Similar to the embodiment of FIG. 1 above, for the check valve 2000 of FIG. 17, in its neutral position, spring force closes the seat between the poppet seat 2410 and the seating structure seat 2420. The interface or “seat” connection is low leakage and designed for structural need. The valve changes modes of operation from the neutral position to flow position when the pressure at the first port 2190 increases. The “crack” setting is also similar to the embodiment of FIG. 1 above. When the force of the pressure at the first port 2190, acting on the effective area of the poppet 2120 is greater than the spring force of the poppet spring 2130, the poppet 2120 moves to the left and opens. When open, fluid flow begins to pass through the valve body 2110 from the first port 2190 to the second port 2195 through the opening created between the poppet seat 2410 and the seating body seat 2420. Additionally. the helical passages or grooves or apertures allow fluid flow to pass between the sides of the poppet 2120 and the interior walls of the valve body 2110 as discussed above.

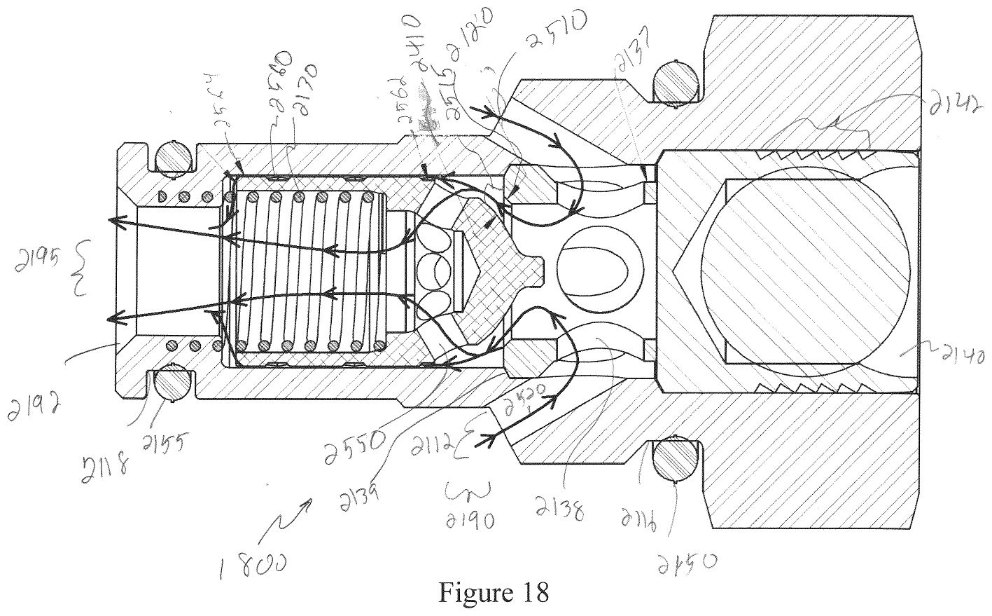

FIG. 18 illustrates the check valve 2000 of FIG. 17 in an “open” or “flow” position 1800 according to an embodiment of the present invention. FIG. 18 shows the valve body 2110, poppet 2120, poppet apertures 2550, poppet spring 2130, valve body entrance orifices 2112, the second port seal engagement insert 2118, the second port seal 2155, the second port outlet 2192, the end plug 2140, the threaded plug portion 2142, the manifold seal 2115, and the manifold seal engagement inset 2116. FIG. 18 also shows the poppet seat 2410, seating structure seat 2420, the poppet grooves 1560, a set of poppet groove inlets 2562, and a set of poppet groove outlets 2564. Also shown is a seating structure ledge 2139 which is part of the valve body 2110 that abuts the seating structure 2137 once the seating structure 2137 is induced into contact with the valve body 2110 by the insertion of the end plug 2140.

As shown in FIG. 18, due to the fluid pressure at the first port 2190 being greater than the fluid pressure at the second port 2195 and greater than the force exerted by the poppet spring 2130, the poppet seat 2410 of the poppet 2120 is displaced from being in contact with the seating structure seat 2420 of the poppet seat 2137. Once that the poppet seat 2410 is displaced from contact with the seating structure seat 2420, fluid begins flowing through a circular or toroidal flow aperture 2515 that appears between the poppet seat 2410 and the seating structure seat 2420.

The flow of fluid from the valve body entrance orifices 2112 through the valve body 2110 is shown by exemplary flow lines 2510, 2520. The exemplary flow lines 2510, 2520 are merely examples of fluid flow and do not illustrate all flow of fluid from the first port 2190 to the second port 2195.

As shown in FIG. 18 and illustrated by the exemplary flow lines 2510, 2520, fluid may pass through the valve body entrance orifices 2112 through the poppet seat apertures 2138, and then through the poppet apertures 2550 into the interior of the poppet 2120 and then out through the second port outlet 2192. This represents a first flow path.

Additionally, fluid may pass through the valve body entrance orifices 2112 through the poppet seat apertures 2138, and then through the series of poppet grooves 2560 located on the exterior of the poppet 2130 by entering at the poppet groove inlets 2562 located near poppet apertures 2550 and exiting at the poppet groove outlets 2564 located near second port outlet 2192. This represents a second flow path.

In operation, as mentioned above, providing multiple flow paths improves the performance of the check valve 2000 by reducing the pressure drop upon activation. This supplemental flow can improve performance by reducing the pressure needed to pass flow (when compared to the current state of art), and less pressure drop equates to less energy loss for the same flow. Additionally, the helical grooves may help center the poppet and prevent hydraulic locking.

The embodiment of FIG. 18 shows the seating structure 2137, which is used to seal the poppet 2130 blocking the flow between ports. The seating structure 2137 allows the poppet embodiments above to be employed in the current embodiment. It is noted that seating structures have not previously been employed for reverse flow cartridge check valves such as the embodiment of FIG. 18.

The “checked flow” mode of operation of the embodiment of FIG. 18 is similar to the previous embodiments, with the flow/pressure direction reversed. Pressure at the second port 2195 pushes the Poppet 2130 against the seating structure 2137. This closes the valve, blocking (or “checking”) flow passage from the first port 2190 to the second port 2195. The present embodiment reduces leakage from the first port to the second port because some valves are used to hold loads or manage hydraulic components where low leakage is important. O-ring seals such as the manifold seal 2150 and second port seal 2155 prevent leakage between the valve body 2110 and manifold. The expander plug or similar plug 2140 to valve body 2110 joint prevents leakage to the atmosphere. The seating structure 2137 to poppet 2130 joint prevents internal leakage from the first port 2190 to the second port 2195.

The seating structure 2137 is new to the present embodiment, but may alternatively be a threaded plug. The seating structure 2137, when installed, does not allow leakage between the poppet 2130 and the seating structure 2137 nor between the seating structure 2137 and the valve body 2110. In one embodiment, the press force of the expander plug may be used to push the seating structure 2137 into contact with the valve body 2110, sealing it.

The embodiment of FIG. 10 may be referred to as the “1 to 2 Standard Performance Cartridge Check Valve” and the embodiment of FIG. 16 may be referred to as the “2-1 Check Valve”.

Additionally, some embodiments of Check valves may use an orifice as part of their function. The function is a check valve with a connection that is always open. The embodiments can readily incorporate an orifice. The orifice is a controlled hole (or aperture) at the nose of the Poppet (or similar location).

As shown above, the poppets in embodiments 1 and 3 may be identical. Additionally, the poppet in embodiment 2 may be identical except the orifice may replace the circumferentially oriented poppet holes. Further, in some embodiments, the orifice may be eliminated.

With regard to the low-mass poppet, lower mass reduces impact energy/force (½*mass*velocity\hat{ }2) during the closing and/or opening of the valve. This may cause check valves to be more resilient to an impact condition. In one embodiment a low-mass poppet may include less mass than a solid poppet by removing material from inside the poppet. For example, the poppet may be hollowed out or turned into a cylindrical shell by removing material along the center axis of the poppet.

In some embodiments, the low mass poppet may include cross holes extending from near the nipple or tip of the poppet and extending though a hollow interior portion of the poppet. The holes may be arranged circumferentially around the nipple or tip of the poppet.

Thus, the poppet allows “through-flow” flow through the poppet from the holes near the tip through the hollowed-out interior of the poppet. The poppet also allows through flow through the grooves located along the exterior of the poppet.

In some embodiments, the low-mass poppet may be composed of lighter weight materials that are lighter than steel. In addition to the Aluminum as mentioned above, alloy steel, plastics, and polymers may be employed. In an embodiment using alloy steel, the pressure drop provided by the check valve may be improved.

In some embodiment, the low-mass poppet may include both lighter-weight materials and be shaped to be hollowed out or turned into a cylindrical shell.

As mentioned above, in some embodiments, the poppet may be made of Aluminum, especially 7075 and 6061 grades of Aluminum. 7075 Aluminum is a “stronger” material that may be suited for high pressure (“high performance”) applications. 6061 Aluminum may be suited for “standard” pressure. In one embodiment, the 3000 psi range (or higher) may be “standard” pressure and the 5000 psi range may be “high pressure”. The ultimate tensile strength of 7075 is in the 70,000 psi range and the ultimate tensile strength of 6061 is in the 40,000 psi range.

In one embodiment, the holes in the poppet are designed to maximize the cross section area through the poppet. In one embodiment, a cross section area that is comparable to the size of the inlet or exit diameter may be targeted. The flow through the valve is a series of restrictions. These restrictions create loses in the form of pressure drop to heat. The larger the holes, the less the restriction—although there is a point of diminishing returns when the area nears the next smaller restriction in the series. Although one or more of the embodiments shown above may employ 8 holes, other embodiments may include holes in the range of 6-12. In the embodiment of the check valve shown above, the poppet may be designed to move ⅛ of an inch during its operation. Thus, the holes may be sized to be ⅛ of an inch. Additionally, the cross-section of the holes may be any shape that can be extruded, including circular, cylindrical, oval, square, rectangular, and rectangular with rounded corners.

The tip or nipple of the poppet may increase stability of the poppet. Additionally, the increased stability of the poppet may reduce noise, which may be desired by the consumer.

In one or more embodiments described above, the helical grooves cross. However, in other embodiments, the helical groves may not cross, for example, the helical grooves may proceed in one direction around the poppet. In other embodiments, the helical grooves may be used to replace the orifice. In some embodiments, for the poppet to move, flow must pass through the grooves. A long, restrictive passage would make for a Poppet that moves slowly. The helical grooves can be used as a method to control the flow across the Poppet. A small orifice may get plugged very easily by debris. However, the helical passage(s) would be resilient to this type of blocking.

In one embodiment the grooves may proceed around the exterior of the poppet at a 38 mm pitch with 10 clockwise and 10 counterclockwise starts/inlets spaced circumferentially around a 9.4 mm diameter poppet. This may represent an angle of about 45 or 50 degrees, although angles in the range from 30-70 degrees may be employed. Additionally, the number of starts may vary in the range from 1-20 and the number of starts in the clockwise and counterclockwise directions may differ. Additionally, one embodiment may employ a single groove. Additionally, in one embodiment, the number of starts/inlets may be in proportion to the size of the poppet. For example, the poppet may include approximately 1 start/inlet per mm of diameter, although anywhere from 0.5-2 starts per mm of diameter may be employed.

With regard to the grooves, one embodiment is shown above in FIG. 15. However, the grooves may be about 1 mm across and 0.3 mm deep. In other embodiments, the grooves may be in the range of 0.5 to 2 mm across and 0.1 to 1 mm deep. Additionally, in various embodiments, the walls of the groove may be angled from 90 to 145 degrees from the base of the groove. Alternatively, the walls may be semi-circular or semi-cylindrical. Additionally, in one embodiment, an orifice may be located in a helical groove. This may improve flow controllability and/or orifice protection. Additionally, more than one orifice may be placed in a groove, for example 2 or 4 orifices. Also, the orifice(s) in the groove may be in addition to orifices located elsewhere on the poppet.

With regard to the holes in the body, on one embodiment, the holes in the body may be maximized in size to be at or near the most restrictive passage in the check valve. In one embodiment, the body may include 8 holes. However, other embodiments may include from 6-12 holes. In embodiments where there are two sets of holes in the body, the number of holes in the first set may differ from the number of holes in the second set. Further, each set may include 8 holes on one embodiment or anywhere from 6-12 holes. Holes that are oriented perpendicularly though the body may be 0.125 inches in diameter in one embodiment, but may vary in the range of 0.075-0.160 inches in diameter. Holes that are oriented at an angle though the body may be 0.094 inches in diameter in one embodiment, but may vary in the range of 0.040-0.150 inches in diameter.

In one embodiment of the body that employs two sets of holes, the slanted set of holes may be oriented so that the egress of the slanted holes through the body is sufficiently close to egress of the perpendicular holes through the body so that both sets of holes may fit within a valve cavity. Alternatively, the slanted set of holes may be oriented so that the egress of the slanted holes is not located within the threaded portion of the body.

In one embodiment the poppet may be called a parabolic poppet because of its roughly parabolic shape.

In one embodiment, the poppet may be called a parabolic poppet because the location where the body seat 1a contacts the poppet seat location 2a may be a parabola. However, in other embodiments, the poppet seat location may be any of spherical, cone, or parabolic while the body seat may be any of parabolic cone or spherical. Additionally, the poppet seat location and body seat may differ in contour.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A check valve including:
a valve body having a first port and a second port; and
a poppet positioned inside said valve body, wherein said poppet includes a poppet exterior surface abutting an interior surface of said valve body, wherein said poppet exterior surface includes at least one poppet groove extending from a poppet groove inlet to a poppet grove outlet,
wherein, when said check valve is displaced from a closed position, fluid travels through said poppet groove from said first port to said second port.

2. The check valve of claim 1 further including a plurality of poppet grooves extending from a plurality of poppet groove inlets to a plurality of poppet groove outlets.

3. The check valve of claim 1 wherein said poppet groove is helical.

4. The check valve of claim 1 wherein said poppet includes a poppet seat, said valve body includes a body seat, and said closed position is when said poppet seat is in contact with said body seat.

5. The check valve of claim 1 wherein said poppet includes at least one orifice.

6. The check valve of claim 1 wherein said poppet includes a bottom edge having at least one groove.

7. The check valve of claim 1 wherein said second port includes a first set of orifices positioned cylindrically around the exterior of said valve body.

8. The check valve of claim 7 wherein said second port also includes a second set of orifices positioned cylindrically around the exterior of the valve body.

9. The check valve of claim 4 wherein said poppet seat is induced to contact said body seat by a poppet spring.

10. The check valve of claim 1 wherein said poppet is hollow and fluid additionally passes through at least one orifice in said poppet through the interior of said poppet and to said second port.

11. A method for controlling fluid flow through a check valve, said method including:
positioning a poppet in the interior of a valve body, wherein said valve body includes a first port and a second port, wherein said poppet includes a poppet exterior surface abutting an interior surface of said valve body, wherein said poppet exterior surface includes at least one poppet groove extending from a poppet groove inlet to a poppet grove outlet; and
displacing said check valve from a closed position to allow fluid to travel through said poppet groove from said first port to said second port.

12. The method of claim 11 further including a plurality of poppet grooves extending from a plurality of poppet groove inlets to a plurality of poppet groove outlets.

13. The method of claim 11 wherein said poppet groove is helical.

14. The method of claim 11 wherein said poppet includes a poppet seat, said valve body includes a body seat, and said closed position is when said poppet seat is in contact with said body seat.

15. The method of claim 11 wherein said poppet includes at least one orifice.

16. The method of claim 11 wherein said poppet includes a bottom edge having at least one groove.

17. The method of claim 11 wherein said second port includes a first set of orifices positioned cylindrically around the exterior of said valve body.

18. The method of claim 17 wherein said second port also includes a second set of orifices positioned cylindrically around the exterior of the valve body.

19. The method of claim 4 wherein said poppet seat is induced to contact said body seat by a poppet spring.

20. The method of claim 11 wherein said poppet is hollow and fluid additionally passes through at least one orifice in said poppet through the interior of said poppet and to said second port.
